(19) United States
(12) Patent Application Publication
(10) Pub. No.: US 2006/0090093 A1
(43) Pub. Date: Apr. 27, 2006

(54) Trouble shooting and updating electronic apparatus

(76) Inventors: Kirby Ryan Goedde, Morristown, IN (US); Angelea Renee Burnett, Fishers, IN (US); Kevin Lloyd Grimes, Fishers, IN (US); Aaron Hal Dinwiddie, Cicero, IN (US); Michael Patrick Begala, Carmel, IN (US)

Correspondence Address: THOMSON LICENSING INC., PATENT OPERATIONS, PO BOX 5312, PRINCETON, NJ, 08543-5312, US

(21) Appl. No.: 10/512,314

(22) PCT Filed: Apr. 17, 2003
(86) PCT No.: PCT/US03/11889

§ 371 Date: Oct. 22, 2004

Related U.S. Application Data
(60) Provisional application No. 60/374,569, filed on Apr. 22, 2002.

(51) Int. Cl. G06F 11/00

(52) U.S. Cl. 714/4

(57) ABSTRACT

An electronic apparatus includes an Ethernet interface for connecting the apparatus to a network; means for assigning an IP address to the apparatus for use by the apparatus to initiate communication with a TCP/IP server in the network having means for diagnosing and/or aligning the electronic appliance; and means for executing commands from the TCP/IP server and for reporting status to the TCP/IP server. The commands are selected from the group consisting of maintenance commands, diagnostic commands, software update commands, and alignment commands.

### CROSS-REFERENCE TO RELATED APPLICATIONS

Benefit of Provisional Patent Application 60/374,569, filed Apr. 22, 2002, is claimed.

### TECHNICAL FIELD OF INVENTION

This invention relates to the field of diagnosing, troubleshooting, aligning, and updating electronic appliances. More particularly the invention relates to systems and methods for servicing television apparatus that are controlled by microprocessors.

### BACKGROUND ART

Electronic appliances controlled by microprocessors such as, for example, modern televisions, can be diagnosed by various methods known in the art. Troubleshooting, alignments, EEPROM manipulation, fault code reporting, and other checks are generally performed by opening the back cover of the appliance and using a computer to communicate with the microprocessors and other chassis components through a serial or parallel interface.

The prior art diagnostic systems consist of an interface box which plugs into the computers parallel port and a serial cable that plugs into the IIC service connector located on the television chassis behind the back cover.

However, until now the removal of the back cover of the appliance being diagnosed was necessary, even though such appliances can often be repaired with diagnostic software alone, i.e., without having to physically touch the hardware on the chassis. Removal of the back cover of the appliance is not only time consuming to the person diagnosing the appliance, but it is also dangerous and presents some risk to the appliance.

Another problem with prior diagnostic procedures was that different models of chassis have different numbers of IIC busses, which the diagnostic software and system must communicate with. The service connector on the chassis is different for each chassis, with different numbers of pins, which required a new adapter board for each type of chassis being diagnosed. Such adapter boards are expensive and can be very confusing to a service person.

### DISCLOSURE OF INVENTION

It is therefore an object of the present invention to obviate the need for removal of the back cover or otherwise open electronic appliances in order to service the appliances.

It is another object of the invention to avoid the need for an interface box to be plugged into an IIC service connector on the chassis of an electronic appliance being repaired.

These objects, and others which will become apparent from the following description, are achieved by the present invention which comprises in one aspect an electronic appliance having a network interface for connecting the apparatus to a network; means for assigning a network address to the apparatus for use by the apparatus to initiate communication with a server connected to the network when the apparatus is in a service mode; and means for executing commands from the server and reporting status to the server.

The electronic apparatus can be a television, satellite receiver, DVD player, VCR, or any other type of electronic appliance which has microcontrollers and other chassis components which can be diagnosed, aligned, and updated with diagnostic software running on a computer; wherein the commands are selected from the group consisting of maintenance commands, diagnostic commands, software update commands, and alignment commands. It is especially advantageous if the apparatus has a readily accessible Ethernet interface to which the test device can be connected without removal of the back cover or otherwise opening the apparatus.

In another aspect, the invention comprises a method of servicing an electronic apparatus comprising providing an Ethernet interface for connecting the apparatus to an Ethernet network; placing the apparatus in a service mode, assigning an IP address to the apparatus for communication with the TCP/IP server; initiating a connection request from the apparatus for connecting to a TCP/IP server through the Ethernet interface; executing commands from the TCP/IP server and reporting status to the TCP/IP server.

The appliance having the Ethernet interface and means to assign an IP address does not have to be opened for service according to the present invention. The appliance may be connected through the Ethernet interface to a diagnostic computer, either local or remotely over the Internet, and therefore the back cover or any other enclosure over the chassis does not have to be removed for diagnosing, servicing, troubleshooting, aligning, debugging, or performing software upgrades to electronic appliances. The Ethernet port can be adapted to perform the functions previously required by the serial or parallel interface inside behind the back cover.

As mentioned, the present invention allows a remote expert to perform diagnostics on appliances over an Internet connection through the Ethernet port on the appliance. The expert can be in any other location in the world, and does not have to be near the appliance being serviced, as was the case with prior diagnostic systems for appliances.

The invention is especially applicable to television apparatus, a form of electronic appliance, which is particularly difficult to service, diagnose, align, and troubleshoot, formerly requiring adapter boards.

### BRIEF DESCRIPTION OF DRAWINGS

FIG. 1 is a process flow diagram of an embodiment of a setup procedure according to the invention.

FIG. 2 is a continuation of the flow diagram of FIG. 1.

FIG. 3 is an embodiment of a block diagram of a television apparatus with integrated browser with Internet connection and Ethernet connection to a diagnostic test device, according to the invention.

### MODES FOR CARRYING OUT THE INVENTION

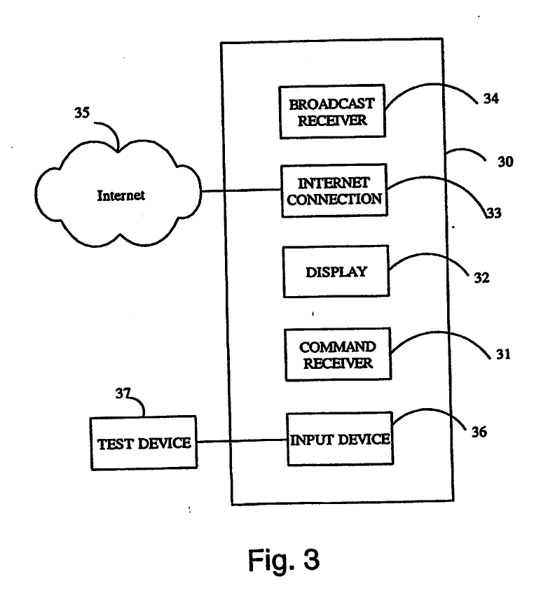

Referring first to FIG. 3, an embodiment of a block diagram of a television apparatus 30 connected to the Internet 35 and connected to a test device 37 through an input device 36 such as an Ethernet connection having an Ethernet port according to the invention is illustrated. The television apparatus 30 has a broadcast (television signal) receiver 34 and display 32, as are conventional for all televisions. The television signals may be supplied from a source such as an antenna or a cable system. The television apparatus 30 also has an Internet connection 33, which includes browser software so that a browser can be displayed on the display 32, as is conventional with most current computers, and is available in some recent models of television. The Internet connection 33 includes, for example, a modem (not shown) for connecting to an Internet service provider, e.g., via a telephone line, via a cable television line, or via a satellite transmitter. A command receiver 31 is included. The command receiver 31 receives commands from a service person entering commands by using a user interface device (not shown) such as a remote control or a front panel with keys in the television apparatus. The command receiver 31 also receives commands from the test device 37 through the input device 36. The television apparatus normally operates in two modes: a normal mode for normal television viewing and Internet browsing, and a service mode television servicing. The command receiver 31 places the television apparatus 30 into the service mode when requested through a user command. The command receiver 31 also executes other commands received and returns responses as necessary.

The command receiver 31 automatically assigns a default IP address for use by the television apparatus 30 to establish a service session by initiating a connection with the test device 37 through the input device 36. As such, the test device 37 should include the default IP address as one of its network addresses. Illustratively, the default IP address of the test device 37 is (169.254.1.0) and the subnet mask should be (255.255.0.0). The command receiver 31 may also receive an IP address of the test device 37 from a user using a user interface and assigns the received IP address as the address for the television apparatus to connect to the test device 37.

When the television apparatus 30 is turned off, battery power or AC power is still available to operate the input device 36, the command receiver 31, and optionally the Internet connection 33 if used in the service mode. The power to the display 32 and the broadcast receiver 34, however, are disconnected.

The test device 37 can be a standard laptop computer or a PC, acting as a server, running Chipper Check™ diagnostic software, available from Thomson Multimedia and sold under the RCA brand. The laptop (server) is connected to the electronic device (in this example a television) functioning as a client, with a standard Ethernet crossover cable, e.g., a cable plugged into an Ethernet port on the back of the television, which does not require removal of the back cover, and does not require any external interface box. The other end of the crossover cable is plugged into the laptop. The laptop is illustratively running a Windows™ operating system and the Chipper Check diagnostic software is an application program of the operating system. Since all Ethernet ports are the same, there is no need for adapter boards. This method of connection allows the diagnostics to be performed over an Internet connection.

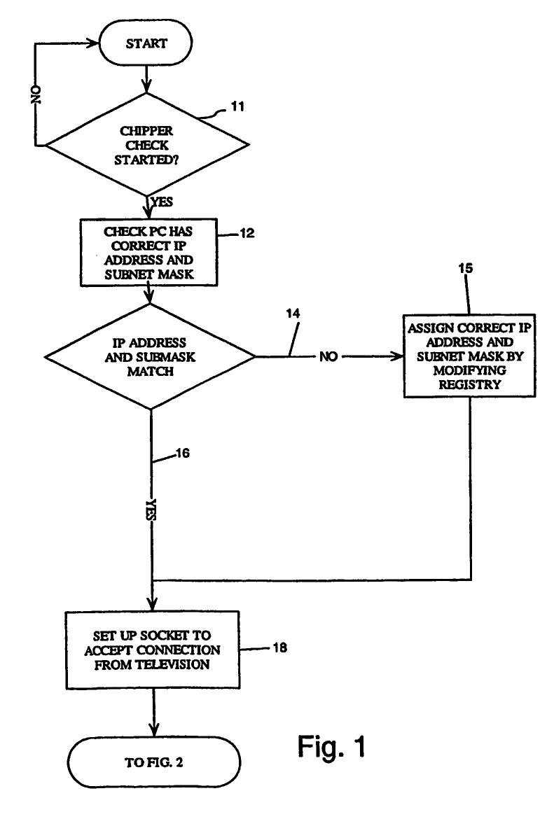

Referring now to FIG. 1, to initialize the TCP/IP connection, a diagnostic program, Chipper Check™ software in this example, is started 11 on a PC, which functions as the test device 37 in FIG. 3. The diagnostic software first checks 12 to see that the PC has assigned the default IP address.

If the PC does not include the default IP address and the default subnet at 13, one of two conditions has occurred (assuming a network card is present in the PC):

1) The computer is not part of a network 14. No IP address or subnet mask is assigned to the card. In this case, the Chipper Check assigns 15 the default IP address and subnet mask to the network card by modifying the Windows registry; or

2) The computer is part of a network 16. The network card already has an IP address and subnet mask assigned to it (either statically or through a DHCP server) but the default IP address is not assigned. In this case, the Chipper Check adds the default IP address and the associated subnet mask by modifying the Windows registry, so that the PC can accept and receive messages using either address.

Once the IP address and subnet mask has been verified, the diagnostic software sets up a socket 18 to accept a connection from the television. The diagnostic software waits for a connection, to be established.

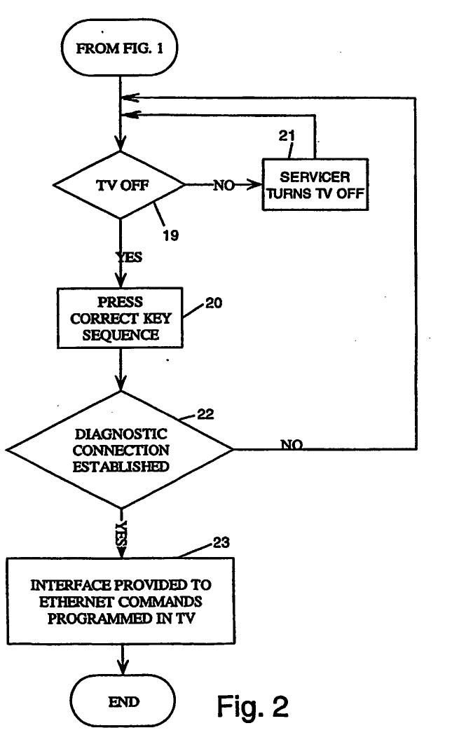

Referring to FIG. 2, once the diagnostic software is in this wait state, the television can initialize the Ethernet connection by entering the service mode. The service mode is illustratively entered by a service person in one of two methods.

In the first method, the service person may place the television in service mode by turning off 21 the television and when the television is off 19 holding down a key sequence 20 from the front panel of the television for a predetermined time, for example, by holding down two keys in the front panel simultaneously for 10 seconds. When the television is placed in the service mode, the television initiate a connection with the PC using the default IP address at 22. It is necessary for the service person to have a way to establish a diagnostic software connection when the television will not turn on. Even though a picture is not present, EEPROM values can be modified, devices can be pinged, and fault codes can be read.

In the second method, the service person turns on the television and invokes a service menu to be displayed on the television screen using keys provided on the front panel. The service menu includes an IP address entry and the service person may enter the IP address using keys on the front panel or on a remote control. After the IP address has been entered, the television is placed on service mode and thereafter initiates a connection with the PC using the entered IP address.

When the television enters service mode, it tries to communicate with the PC with the IP address described above. If a connection is established 22, the diagnostic software provides 23 a user interface to send commands and receive responses from the television through an Ethernet interface such as the input device 36 in FIG. 3. These commands provide the basic Chipper Check functionality.

The television software can be upgraded in one embodiment by disconnecting power sources from the television and then holding down a combination of front panel keys while the television is reconnected to the power sources, causing the PC to act as an FTP server and the television to log into the PC, request files, and upgrade the software.

Referring back to FIG. 3, although the test device 37 is illustrated as connecting to the television apparatus 30 through a local Ethernet port included in the input device 36, the test device 37 can be connected to the Internet network 35 and the television apparatus 30 may connect to the test device 37 through the Internet connection 33.

While the invention has been described in sufficient detail that those skilled in this art can readily make and use it, various alternatives, modifications, and improvements should become readily apparent without departing from the spirit and scope of the invention. For example, although TCP/IP is illustrated, other protocols such as OSI Reference Model can be used as well.

1. An electronic apparatus operating in a selected one of normal and service modes, the electronic apparatus comprising:
a first network interface for connecting the apparatus to a first network;
means for assigning a network address to the apparatus for use by the apparatus to initiate communication with a server connected to the first network via the first network interface when the apparatus is in the service mode; and
means for executing commands from the server and reporting status to the server.

2. The electronic apparatus of claim 1 wherein the first network is an Ethernet network and the first network interface is an Ethernet network interface.

3. The electronic apparatus of claim 2 wherein the electronic apparatus establishes a connection-oriented connection with the server.

4. The electronic apparatus of claim 3 wherein the connection-oriented connection is a TCP connection.

5. The electronic apparatus of claim 4 wherein the electronic apparatus is a television apparatus.

6. The electronic apparatus of claim 5 further comprising a signal receiver for receiving television signals.

7. The electronic apparatus of claim 6 wherein the commands are selected from the group consisting of maintenance commands, control commands, diagnostic commands, software update commands, and alignment commands.

8. The electronic apparatus of claim 6 further comprising means for placing the television apparatus in a service mode.

9. The apparatus of claim 8 wherein the placing means places the apparatus in the service mode when the placing means receives a signal from a service person, indicating that the service person holds down a key sequence for a predetermined time.

10. The apparatus of claim 8 wherein the placing means places the apparatus in service mode when the placing means receives a first network address from a service person from a user interface mechanism, the first network address being a network address of the server.

11. The electronic apparatus of claim 6 further comprising means for assigning an IP address to the television apparatus for communication with the server.

12. The electronic apparatus of claim 11 wherein the assigning means automatically assigns a default IP address as an IP address of the server.

13. The electronic apparatus of claim 11 wherein the assigning means receives an IP address from a service person entering the IP address from a user interface mechanism.

14. The electronic apparatus of claim 13 wherein after the assigning means has received the IP address, the apparatus is placed in the service mode and the apparatus automatically initiates the connection with the server addressed by the IP address.

15. The apparatus of claim 6, where in the apparatus comprises software and the apparatus further comprises means for upgrading the software by holding down a combination of front panel keys while the apparatus, causing the server to act as an FTP server and the apparatus to log into the server, request files, and upgrade the software.

16. The electronic apparatus of claim 2 further comprising a second network interface for connecting to an Internet network.

17. The electronic apparatus of claim 1 wherein the first network is an Internet network.

18. The electronic apparatus of claim 17 wherein the first network interface comprises a cable modem.

19. A method of diagnosing and/or aligning an electronic apparatus having normal and service modes of operation, the method comprising the steps of:
providing a first network interface for connecting the apparatus to a first network;
placing the apparatus in the service mode;
assigning a network address to the apparatus for communication with a server connected to the first network;
initiating a connection request from the apparatus for connecting to the server through the first network interface; and
receiving and executing commands from the server to the electronic apparatus, and reporting status of the electronic apparatus to the server.

20. The method of claim 19 wherein the electronic apparatus is a television apparatus.

21. The method of claim 20 wherein the first network is an Ethernet network and the first network interface is an Ethernet network interface.

22. The method of claim 21 wherein the connection request is a TCP connection request.

23. The method of claim 22 wherein the commands are selected from the group consisting of maintenance commands, diagnostic commands, software update commands, and alignment commands.

24. The method of claim 20 wherein the placing step comprises the step of turning off the apparatus and holding down a key sequence for a predetermined time, and the initiating step uses a default network address for connecting to the server.

25. The method of claim 22, wherein the placing step comprises the step of entering an IP address of the server into a service menu, and the initiating step uses the IP address for connecting to the server.

26. The method of claim 19 wherein the first network is an Internet network.

27. The method of claim 26 wherein the first network interface comprises a cable modem.
